(19) United States
(12) Patent Application Publication
(10) Pub. No.: US 2020/0185138 A1
(43) Pub. Date: Jun. 11, 2020

(54) INDUCTOR STRUCTURES

(71) Applicant: Vanguard International Semiconductor Corporation, Hsinchu (TW)

(72) Inventors: Chien-Nan LIAO, Taichung City (TW); Bo-Yuan SU, Tainan City (TW); Jui-Chun CHANG, Hsinchu City (TW)

(73) Assignee: Vanguard International Semiconductor Corporation, Hsinchu (TW)

(21) Appl. No.: 16/210,558

(22) Filed: Dec. 5, 2018

(51) Int. Cl. H01F 17/00; H01F 27/28; H01F 27/36

(52) U.S. Cl. CPC H01F 17/0013; H01F 27/2871; H01F 41/041; H01F 27/2804; H01F 27/289; H01F 27/362

(57) ABSTRACT

An inductor structure is provided. The inductor structure includes a substrate, a first dielectric layer formed on the substrate, a first metal layer formed in the first dielectric layer, a second dielectric layer formed on the first dielectric layer, a second metal layer formed in the second dielectric layer, at least one intermediate dielectric layer formed between the first and second dielectric layers, at least one intermediate metal layer formed in the intermediate dielectric layer, and a plurality of vias connected to the first metal layer and the intermediate metal layer. The vias are connected to the second metal layer and the intermediate metal layer. The first metal layer, the vias, the intermediate metal layer, and the second metal layer form an extension path which extends in a spiral mode.

### TECHNICAL FIELD

The technical field relates to an inductor structure with a large wire width and low occupied area.

### BACKGROUND

With current planar inductors, the higher the required inductance value, the more inductive turns of the component, and therefore the larger the area it occupies on a wafer. In order to prevent interference between the inductor components and other components, the region below the inductor component is set as a component-free area, i.e. no components or metal layers are disposed therein. Also, within a certain distance from the inductor component, it must be a component-free area. The above limitations cause the wafer to have a very poor use of space.

Current planar inductors use a single metal layer, and the underlying metal layer acts as a connection wire to allow it to connect to other components. Limited by the processing factors, it must be designed to meet the requirements of minimum metal spacing, and a wider metal wire with more inductive turns is required in order to increase the inductance value. However, due to those processing and design requirements, there are always insurmountable difficulties in the use of the area of the wafer.

Therefore, development of an inductor structure with a large wire width and low occupied area is desirable.

### SUMMARY

In accordance with one embodiment of the invention, an inductor structure is provided. The inductor structure includes a substrate, a first dielectric layer, a first metal layer, a second dielectric layer, a second metal layer, at least one intermediate dielectric layer, at least one intermediate metal layer, and a plurality of vias. The first dielectric layer is formed on the substrate. The first metal layer is formed in the first dielectric layer. The second dielectric layer is formed on the first dielectric layer. The second metal layer is formed in the second dielectric layer. The first and second metal layers are continuous metal layers. The intermediate dielectric layer is formed between the first and second dielectric layers. The intermediate metal layer is formed in the intermediate dielectric layer. The intermediate metal layer is a patterned metal layer. The vias are connected to the first metal layer and the intermediate metal layer and connected to the second metal layer and the intermediate metal layer. The first metal layer, the via, the intermediate metal layer, the via, the second metal layer, the via, and the intermediate metal layer form an extension path which extends in a counterclockwise spiral mode. The starting point of the extension path is the first metal layer.

In some embodiments, the length of the first metal layer, the second metal layer and the intermediate metal layer is in a range from about 1 μm to about 100 μm. In some embodiments, the thickness of the first metal layer, the second metal layer and the intermediate metal layer is in a range from about 0.01 μm to about 4 μm. In some embodiments, the width of the first metal layer, the second metal layer and the intermediate metal layer is in a range from about 0.01 μm to about 100 μm. In some embodiments, the spacing of the patterned metal layer of the intermediate metal layer is in a range from about 0.01 μm to about 10 μm.

In some embodiments, the intermediate dielectric layer includes a single-layer intermediate dielectric layer, and the intermediate metal layer includes a single-layer intermediate metal layer. In some embodiments, the intermediate dielectric layer includes dual-layer intermediate dielectric layers, and the intermediate metal layer includes dual-layer intermediate metal layers. In some embodiments, when the intermediate metal layer includes dual-layer intermediate metal layers, the inductor structure further includes a plurality of vias connected to the intermediate metal layers which are located at different layers. In some embodiments, the intermediate dielectric layer includes triple-layer intermediate dielectric layers, and the intermediate metal layer includes triple-layer intermediate metal layers. In some embodiments, when the intermediate metal layer includes triple-layer intermediate metal layers, the inductor structure further includes a plurality of vias connected to the intermediate metal layers which are located at different layers.

In accordance with one embodiment of the invention, an inductor structure is provided. The inductor structure includes a substrate, a first dielectric layer, a first metal layer, a second dielectric layer, a second metal layer, at least one intermediate dielectric layer, at least one intermediate metal layer, and a plurality of vias. The first dielectric layer is formed on the substrate. The first metal layer is formed in the first dielectric layer. The second dielectric layer is formed on the first dielectric layer. The second metal layer is formed in the second dielectric layer. The first and second metal layers are continuous metal layers. The intermediate dielectric layer is formed between the first and second dielectric layers. The intermediate metal layer is formed in the intermediate dielectric layer. The intermediate metal layer is a patterned metal layer. The vias are connected to the first metal layer and the intermediate metal layer and connected to the second metal layer and the intermediate metal layer. The first metal layer, the via, the intermediate metal layer, the via, the second metal layer, the via, and the intermediate metal layer form an extension path which extends in a clockwise spiral mode. The starting point of the extension path is the first metal layer.

The present invention provides a specific connection manner to connect metal layers and vias along a vertical direction to fabricate an inductor component. To increase the number of inductive turns of the inductor component, it is only necessary to increase the number of layers of the metal layer along the vertical direction. That is, the increase in the number of inductive turns of the inductor component does not cause an increase in the area occupied on the plane (i.e. along the horizontal direction). Also, the fabrication process of the present invention is not difficult, and it can be combined with general semiconductor processes to fabricate the component easily. In addition, the present invention does possess a considerable process window when various wire widths of metal wires are designed to be fabricated. That is, there is no need to worry that arbitrarily increasing the wire width of the metal wires will cause a loading of the area occupied by the component, so an inductor component having any appropriate wire width can be easily fabricated. Furthermore, due to the reduced area occupied on the plane (i.e. along the horizontal direction), the effects of the inductor component of the present invention on adjacent component regions are substantially reduced, particularly the restrictions on the area used by adjacent components. That is, the present invention provides more convenient options for the placement of various other components.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a cross-sectional view of an inductor structure in accordance with one embodiment of the invention;

FIG. 1A is a cross-sectional view of an inductor structure taken along line A-A′ of FIG. 1 in accordance with one embodiment of the invention;

FIG. 2 is a cross-sectional view of an inductor structure in accordance with one embodiment of the invention;

FIG. 2A is a cross-sectional view of an inductor structure taken along line A-A′ of FIG. 2 in accordance with one embodiment of the invention;

FIG. 3 is a cross-sectional view of an inductor structure in accordance with one embodiment of the invention;

FIG. 3A is a cross-sectional view of an inductor structure taken along line A-A′ of FIG. 3 in accordance with one embodiment of the invention;

FIG. 4 is a cross-sectional view of an inductor structure in accordance with one embodiment of the invention;

FIG. 4A is a cross-sectional view of an inductor structure taken along line A-A′ of FIG. 4 in accordance with one embodiment of the invention;

FIG. 5 is a cross-sectional view of an inductor structure in accordance with one embodiment of the invention;

FIG. 5A is a cross-sectional view of an inductor structure taken along line A-A′ of FIG. 5 in accordance with one embodiment of the invention;

FIG. 6 is a cross-sectional view of an inductor structure in accordance with one embodiment of the invention; and

FIG. 6A is a cross-sectional view of an inductor structure taken along line A-A′ of FIG. 6 in accordance with one embodiment of the invention.

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

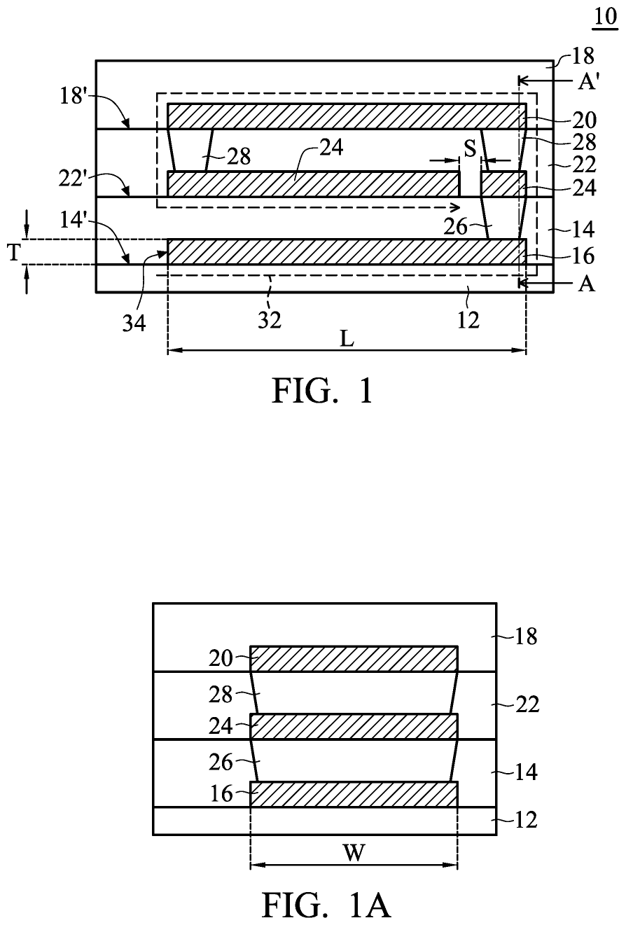

Referring to FIG. 1, in accordance with one embodiment of the invention, an inductor structure 10 is provided. FIG. 1 is a cross-sectional view of the inductor structure 10.

As shown in FIG. 1, in this embodiment, the inductor structure 10 includes a substrate 12, a first dielectric layer 14, a first metal layer 16, a second dielectric layer 18, a second metal layer 20, an intermediate dielectric layer 22, an intermediate metal layer 24, and a plurality of vias (26 and 28). The first dielectric layer 14 is formed on the substrate 12. The first metal layer 16 is formed in the first dielectric layer 14 and located on the bottom 14′ of the first dielectric layer 14. The second dielectric layer 18 is formed on the first dielectric layer 14. The second metal layer 20 is formed in the second dielectric layer 18 and located on the bottom 18′ of the second dielectric layer 18. The first metal layer 16 and the second metal layer 20 are continuous metal layers. The intermediate dielectric layer 22 is formed between the first dielectric layer 14 and the second dielectric layer 18. The intermediate metal layer 24 is formed in the intermediate dielectric layer 22 and located on the bottom 22′ of the intermediate dielectric layer 22. The intermediate metal layer 24 is a patterned metal layer.

In addition, the vias (26 and 28) are connected to the first metal layer 16 and the intermediate metal layer 24 and connected to the second metal layer 20 and the intermediate metal layer 24. For example, the via 26 is connected to the first metal layer 16 and the intermediate metal layer 24. The via 28 is connected to the second metal layer 20 and the intermediate metal layer 24. Specifically, the first metal layer 16, the via 26, the intermediate metal layer 24, the via 28, the second metal layer 20, the via 28 and the intermediate metal layer 24 form an extension path 32 which extends in a counterclockwise spiral mode. The extension path 32 takes the starting point 34 of the first metal layer 16 as an extension starting point, as shown in FIG. 1.

In some embodiments, the substrate 12 includes a silicon substrate or other suitable substrate materials. In some embodiments, the first dielectric layer 14, the second dielectric layer 18 and the intermediate dielectric layer 22 include silicon nitride, silicon oxide, silicon oxynitride or other suitable low-dielectric-constant dielectric materials. In some embodiments, the first metal layer 16, the second metal layer 20 and the intermediate metal layer 24 include copper, aluminum or other suitable metal conductive materials. In some embodiments, the vias (26 and 28) are filled with copper, tungsten or other suitable metal conductive materials.

In some embodiments, the length “L” of the first metal layer 16, the second metal layer 20 and the intermediate metal layer 24 is in a range from about 1 μm to about 100 μm. In some embodiments, the thickness “T” of the first metal layer 16, the second metal layer 20 and the intermediate metal layer 24 is in a range from about 0.01 μm to about 4 μm. In some embodiments, the width “W” of the first metal layer 16, the second metal layer 20 and the intermediate metal layer 24 is in a range from about 0.01 μm to about 100 μm, as shown in FIG. 1A. FIG. 1A is a cross-sectional view taken along line A-A′ of FIG. 1. In some embodiments, the spacing “S” of the patterned metal layer of the intermediate metal layer 24 is in a range from about 0.01 μm to about 10 μm.

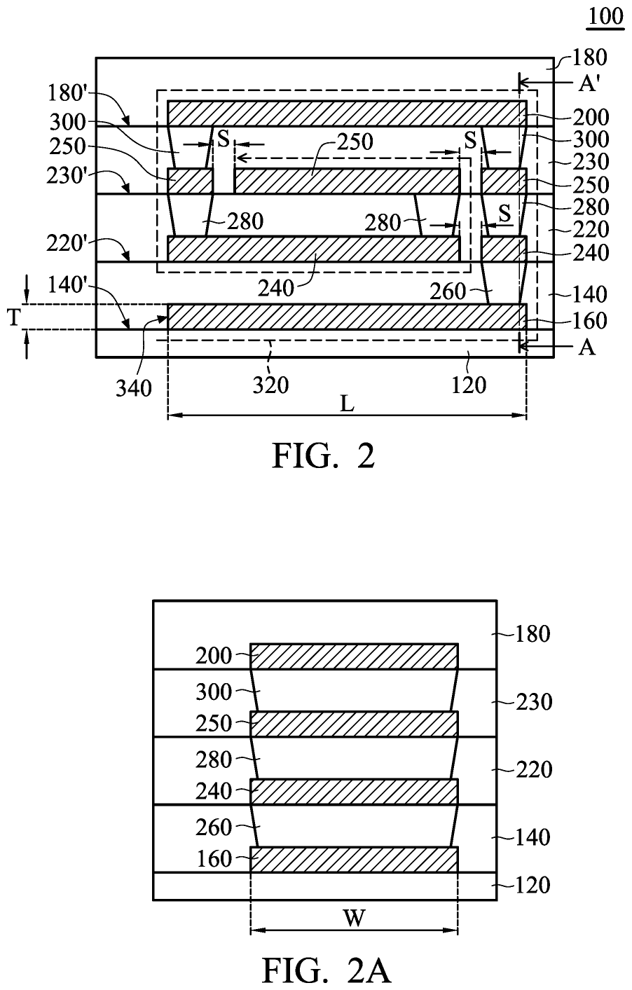

Referring to FIG. 2, in accordance with one embodiment of the invention, an inductor structure 100 is provided. FIG. 2 is a cross-sectional view of the inductor structure 100.

As shown in FIG. 2, in this embodiment, the inductor structure 100 includes a substrate 120, a first dielectric layer 140, a first metal layer 160, a second dielectric layer 180, a second metal layer 200, a first intermediate dielectric layer 220, a second intermediate dielectric layer 230, a first intermediate metal layer 240, a second intermediate metal layer 250, and a plurality of vias (260, 280 and 300). The first dielectric layer 140 is formed on the substrate 120. The first metal layer 160 is formed in the first dielectric layer 140 and located on the bottom 140′ of the first dielectric layer 140. The second dielectric layer 180 is formed on the first dielectric layer 140. The second metal layer 200 is formed in the second dielectric layer 180 and located on the bottom 180′ of the second dielectric layer 180. The first metal layer 160 and the second metal layer 200 are continuous metal layers. The first intermediate dielectric layer 220 is formed on the first dielectric layer 140. The first intermediate metal layer 240 is formed in the first intermediate dielectric layer 220 and located on the bottom 220′ of the first intermediate dielectric layer 220. The second intermediate dielectric layer 230 is formed on the first intermediate dielectric layer 220. The second intermediate metal layer 250 is formed in the second intermediate dielectric layer 230 and located on the bottom 230′ of the second intermediate dielectric layer 230. The first intermediate metal layer 240 and the second intermediate metal layer 250 are patterned metal layers.

The vias (260, 280 and 300) are connected to the first metal layer 160 and the first intermediate metal layer 240, connected to the first intermediate metal layer 240 and the second intermediate metal layer 250, and connected to the second metal layer 200 and the second intermediate metal layer 250. For example, the via 260 is connected to the first metal layer 160 and the first intermediate metal layer 240. The via 280 is connected to the first intermediate metal layer 240 and the second intermediate metal layer 250. The via 300 is connected to the second metal layer 200 and the second intermediate metal layer 250. Specifically, the first metal layer 160, the via 260, the first intermediate metal layer 240, the via 280, the second intermediate metal layer 250, the via 300, the second metal layer 200, the via 300, the second intermediate metal layer 250, the via 280, the first intermediate metal layer 240, the via 280, and the second intermediate metal layer 250 form an extension path 320 which extends in a counterclockwise spiral mode. The extension path 320 takes the starting point 340 of the first metal layer 160 as an extension starting point, as shown in FIG. 2.

In some embodiments, the substrate 120 includes a silicon substrate or other suitable substrate materials. In some embodiments, the first dielectric layer 140, the second dielectric layer 180, the first intermediate dielectric layer 220 and the second intermediate dielectric layer 230 include silicon nitride, silicon oxide, silicon oxynitride or other suitable low-dielectric-constant dielectric materials. In some embodiments, the first metal layer 160, the second metal layer 200, the first intermediate metal layer 240 and the second intermediate metal layer 250 include copper, aluminum or other suitable metal conductive materials. In some embodiments, the vias (260, 280 and 300) are filled with copper, tungsten or other suitable metal conductive materials.

In some embodiments, the length “L” of the first metal layer 160, the second metal layer 200, the first intermediate metal layer 240 and the second intermediate metal layer 250 is in a range from about 1 μm to about 100 μm. In some embodiments, the thickness “T” of the first metal layer 160, the second metal layer 200, the first intermediate metal layer 240 and the second intermediate metal layer 250 is in a range from about 0.01 μm to about 4 μm. In some embodiments, the width “W” of the first metal layer 160, the second metal layer 200, the first intermediate metal layer 240 and the second intermediate metal layer 250 is in a range from about 0.01 μm to about 100 μm, as shown in FIG. 2A. FIG. 2A is a cross-sectional view taken along line A-A′ of FIG. 2. In some embodiments, the spacing “S” of the patterned metal layers of the first intermediate metal layer 240 and the second intermediate metal layer 250 is in a range from about 0.01 μm to about 10 μm.

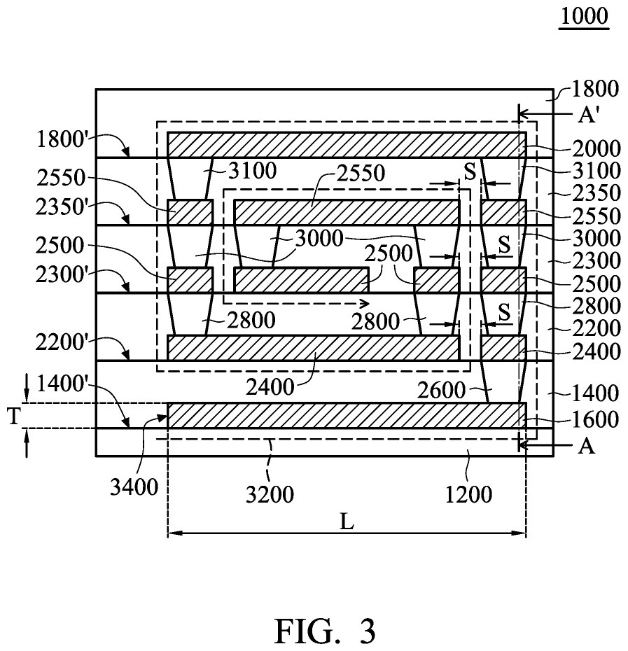

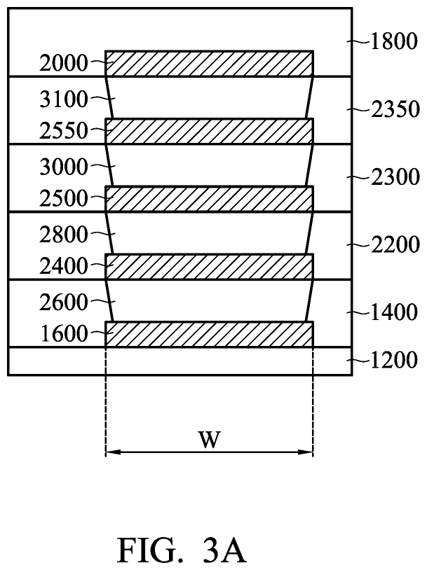

Referring to FIG. 3, in accordance with one embodiment of the invention, an inductor structure 1000 is provided. FIG. 3 is a cross-sectional view of the inductor structure 1000.

As shown in FIG. 3, in this embodiment, the inductor structure 1000 includes a substrate 1200, a first dielectric layer 1400, a first metal layer 1600, a second dielectric layer 1800, a second metal layer 2000, a first intermediate dielectric layer 2200, a second intermediate dielectric layer 2300, a third intermediate dielectric layer 2350, a first intermediate metal layer 2400, a second intermediate metal layer 2500, a third intermediate metal layer 2550, and a plurality of vias (2600, 2800, 3000 and 3100). The first dielectric layer 1400 is formed on the substrate 1200. The first metal layer 1600 is formed in the first dielectric layer 1400 and located on the bottom 1400′ of the first dielectric layer 1400. The second dielectric layer 1800 is formed on the first dielectric layer 1400. The second metal layer 2000 is formed in the second dielectric layer 1800 and located on the bottom 1800′ of the second dielectric layer 1800. The first metal layer 1600 and the second metal layer 2000 are continuous metal layers. The first intermediate dielectric layer 2200 is formed on the first dielectric layer 1400. The first intermediate metal layer 2400 is formed in the first intermediate dielectric layer 2200 and located on the bottom 2200′ of the first intermediate dielectric layer 2200. The second intermediate dielectric layer 2300 is formed on the first intermediate dielectric layer 2200. The second intermediate metal layer 2500 is formed in the second intermediate dielectric layer 2300 and located on the bottom 2300′ of the second intermediate dielectric layer 2300. The third intermediate dielectric layer 2350 is formed on the second intermediate dielectric layer 2300. The third intermediate metal layer 2550 is formed in the third intermediate dielectric layer 2350 and located on the bottom 2350′ of the third intermediate dielectric layer 2350. The first intermediate metal layer 2400, the second intermediate metal layer 2500 and the third intermediate metal layer 2550 are patterned metal layers.

The vias (2600, 2800, 3000 and 3100) are connected to the first metal layer 1600 and the first intermediate metal layer 2400, connected to the first intermediate metal layer 2400 and the second intermediate metal layer 2500, connected to the second intermediate metal layer 2500 and the third intermediate metal layer 2550, and connected to the second metal layer 2000 and the third intermediate metal layer 2550. For example, the via 2600 is connected to the first metal layer 1600 and the first intermediate metal layer 2400. The via 2800 is connected to the first intermediate metal layer 2400 and the second intermediate metal layer 2500. The via 3000 is connected to the second intermediate metal layer 2500 and the third intermediate metal layer 2550. The via 3100 is connected to the second metal layer 2000 and the third intermediate metal layer 2550. Specifically, the first metal layer 1600, the via 2600, the first intermediate metal layer 2400, the via 2800, the second intermediate metal layer 2500, the via 3000, the third intermediate metal layer 2550, the via 3100, the second metal layer 2000, the via 3100, the third intermediate metal layer 2550, the via 3000, the second intermediate metal layer 2500, the via 2800, the first intermediate metal layer 2400, the via 2800, the second intermediate metal layer 2500, the via 3000, the third intermediate metal layer 2550, the via 3000, and the second intermediate metal layer 2500 form an extension path 3200 which extends in a counterclockwise spiral mode. Similarly, the extension path 3200 takes the starting point 3400 of the first metal layer 1600 as an extension starting point, as shown in FIG. 3.

In some embodiments, the substrate 1200 includes a silicon substrate or other suitable substrate materials. In some embodiments, the first dielectric layer 1400, the second dielectric layer 1800, the first intermediate dielectric layer 2200, the second intermediate dielectric layer 2300 and the third intermediate dielectric layer 2350 include silicon nitride, silicon oxide, silicon oxynitride or other suitable low-dielectric-constant dielectric materials. In some embodiments, the first metal layer 1600, the second metal layer 2000, the first intermediate metal layer 2400, the second intermediate metal layer 2500 and the third intermediate metal layer 2550 include copper, aluminum or other suitable metal conductive materials. In some embodiments, the vias (2600, 2800, 3000 and 3100) are filled with, for example, copper, tungsten or other suitable metal conductive materials.

In some embodiments, the length “L” of the first metal layer 1600, the second metal layer 2000, the first intermediate metal layer 2400, the second intermediate metal layer 2500 and the third intermediate metal layer 2550 is in a range from about 1 μm to about 100 μm. In some embodiments, the thickness “T” of the first metal layer 1600, the second metal layer 2000, the first intermediate metal layer 2400, the second intermediate metal layer 2500 and the third intermediate metal layer 2550 is in a range from about 0.01 μm to about 4 μm. In some embodiments, the width “W” of the first metal layer 1600, the second metal layer 2000, the first intermediate metal layer 2400, the second intermediate metal layer 2500 and the third intermediate metal layer 2550 is in a range from about 0.01 μm to about 100 μm, as shown in FIG. 3A. FIG. 3A is a cross-sectional view taken along line A-A′ of FIG. 3. In some embodiments, the spacing “S” of the patterned metal layers of the first intermediate metal layer 2400, the second intermediate metal layer 2500 and the third intermediate metal layer 2550 is in a range from about 0.01 μm to about 10 μm.

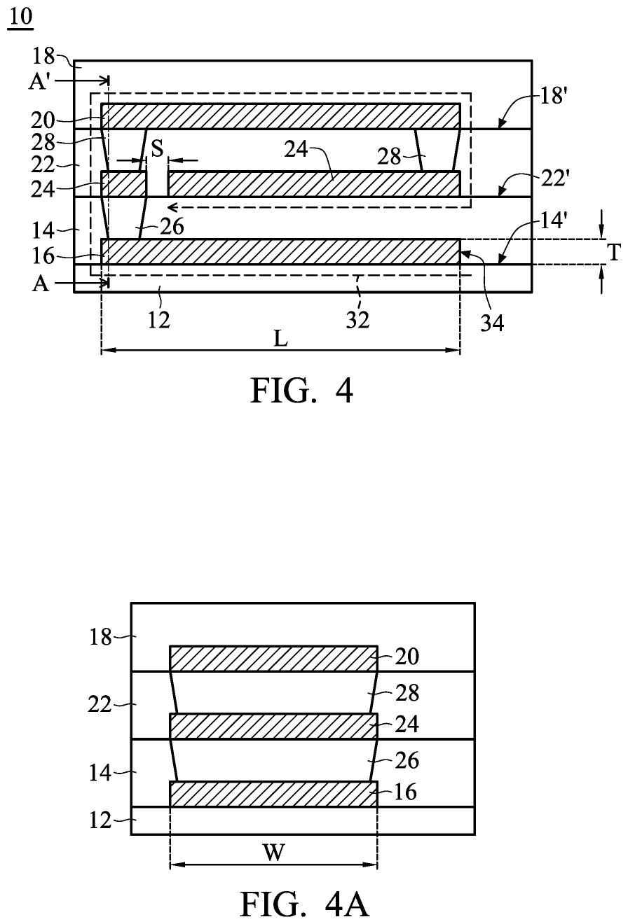

Referring to FIG. 4, in accordance with one embodiment of the invention, an inductor structure 10 is provided. FIG. 4 is a cross-sectional view of the inductor structure 10.

As shown in FIG. 4, in this embodiment, the inductor structure 10 includes a substrate 12, a first dielectric layer 14, a first metal layer 16, a second dielectric layer 18, a second metal layer 20, an intermediate dielectric layer 22, an intermediate metal layer 24, and a plurality of vias (26 and 28). The first dielectric layer 14 is formed on the substrate 12. The first metal layer 16 is formed in the first dielectric layer 14 and located on the bottom 14′ of the first dielectric layer 14. The second dielectric layer 18 is formed on the first dielectric layer 14. The second metal layer 20 is formed in the second dielectric layer 18 and located on the bottom 18′ of the second dielectric layer 18. The first metal layer 16 and the second metal layer 20 are continuous metal layers. The intermediate dielectric layer 22 is formed between the first dielectric layer 14 and the second dielectric layer 18. The intermediate metal layer 24 is formed in the intermediate dielectric layer 22 and located on the bottom 22′ of the intermediate dielectric layer 22. The intermediate metal layer 24 is a patterned metal layer.

In addition, the vias (26 and 28) are connected to the first metal layer 16 and the intermediate metal layer 24 and connected to the second metal layer 20 and the intermediate metal layer 24. For example, the via 26 is connected to the first metal layer 16 and the intermediate metal layer 24. The via 28 is connected to the second metal layer 20 and the intermediate metal layer 24. Specifically, the first metal layer 16, the via 26, the intermediate metal layer 24, the via 28, the second metal layer 20, the via 28 and the intermediate metal layer 24 form an extension path 32 which extends in a clockwise spiral mode. The extension path 32 takes the starting point 34 of the first metal layer 16 as an extension starting point, as shown in FIG. 4.

In some embodiments, the substrate 12 includes a silicon substrate or other suitable substrate materials. In some embodiments, the first dielectric layer 14, the second dielectric layer 18 and the intermediate dielectric layer 22 include silicon nitride, silicon oxide, silicon oxynitride or other suitable low-dielectric-constant dielectric materials. In some embodiments, the first metal layer 16, the second metal layer 20 and the intermediate metal layer 24 include copper, aluminum or other suitable metal conductive materials. In some embodiments, the vias (26 and 28) are filled with copper, tungsten or other suitable metal conductive materials.

In some embodiments, the length “L” of the first metal layer 16, the second metal layer 20 and the intermediate metal layer 24 is in a range from about 1 μm to about 100 μm. In some embodiments, the thickness “T” of the first metal layer 16, the second metal layer 20 and the intermediate metal layer 24 is in a range from about 0.01 μm to about 4 μm. In some embodiments, the width “W” of the first metal layer 16, the second metal layer 20 and the intermediate metal layer 24 is in a range from about 0.01 μm to about 100 μm, as shown in FIG. 4A. FIG. 4A is a cross-sectional view taken along line A-A′ of FIG. 4. In some embodiments, the spacing “S” of the patterned metal layer of the intermediate metal layer 24 is in a range from about 0.01 μm to about 10 μm.

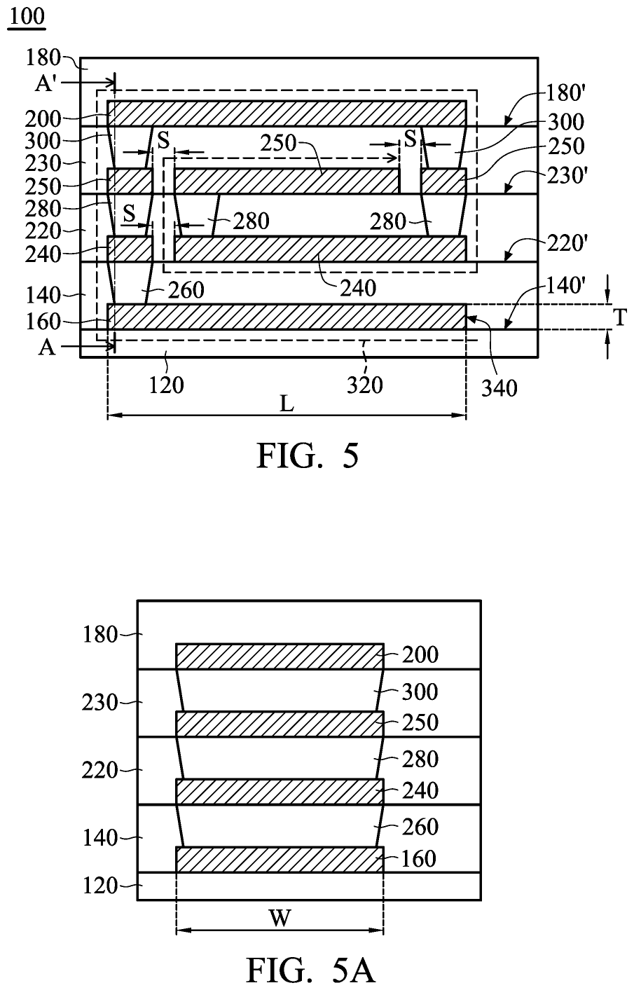

Referring to FIG. 5, in accordance with one embodiment of the invention, an inductor structure 100 is provided. FIG. 5 is a cross-sectional view of the inductor structure 100.

As shown in FIG. 5, in this embodiment, the inductor structure 100 includes a substrate 120, a first dielectric layer 140, a first metal layer 160, a second dielectric layer 180, a second metal layer 200, a first intermediate dielectric layer 220, a second intermediate dielectric layer 230, a first intermediate metal layer 240, a second intermediate metal layer 250, and a plurality of vias (260, 280 and 300). The first dielectric layer 140 is formed on the substrate 120. The first metal layer 160 is formed in the first dielectric layer 140 and located on the bottom 140′ of the first dielectric layer 140. The second dielectric layer 180 is formed on the first dielectric layer 140. The second metal layer 200 is formed in the second dielectric layer 180 and located on the bottom 180′ of the second dielectric layer 180. The first metal layer 160 and the second metal layer 200 are continuous metal layers. The first intermediate dielectric layer 220 is formed on the first dielectric layer 140. The first intermediate metal layer 240 is formed in the first intermediate dielectric layer 220 and located on the bottom 220′ of the first intermediate dielectric layer 220. The second intermediate dielectric layer 230 is formed on the first intermediate dielectric layer 220. The second intermediate metal layer 250 is formed in the second intermediate dielectric layer 230 and located on the bottom 230′ of the second intermediate dielectric layer 230. The first intermediate metal layer 240 and the second intermediate metal layer 250 are patterned metal layers.

The vias (260, 280 and 300) are connected to the first metal layer 160 and the first intermediate metal layer 240, connected to the first intermediate metal layer 240 and the second intermediate metal layer 250, and connected to the second metal layer 200 and the second intermediate metal layer 250. For example, the via 260 is connected to the first metal layer 160 and the first intermediate metal layer 240. The via 280 is connected to the first intermediate metal layer 240 and the second intermediate metal layer 250. The via 300 is connected to the second metal layer 200 and the second intermediate metal layer 250. Specifically, the first metal layer 160, the via 260, the first intermediate metal layer 240, the via 280, the second intermediate metal layer 250, the via 300, the second metal layer 200, the via 300, the second intermediate metal layer 250, the via 280, the first intermediate metal layer 240, the via 280, and the second intermediate metal layer 250 form an extension path 320 which extends in a clockwise spiral mode. The extension path 320 takes the starting point 340 of the first metal layer 160 as an extension starting point, as shown in FIG. 5.

In some embodiments, the substrate 120 includes a silicon substrate or other suitable substrate materials. In some embodiments, the first dielectric layer 140, the second dielectric layer 180, the first intermediate dielectric layer 220 and the second intermediate dielectric layer 230 include silicon nitride, silicon oxide, silicon oxynitride or other suitable low-dielectric-constant dielectric materials. In some embodiments, the first metal layer 160, the second metal layer 200, the first intermediate metal layer 240 and the second intermediate metal layer 250 include copper, aluminum or other suitable metal conductive materials. In some embodiments, the vias (260, 280 and 300) are filled with copper, tungsten or other suitable metal conductive materials.

In some embodiments, the length “L” of the first metal layer 160, the second metal layer 200, the first intermediate metal layer 240 and the second intermediate metal layer 250 is in a range from about 1 μm to about 100 μm. In some embodiments, the thickness “T” of the first metal layer 160, the second metal layer 200, the first intermediate metal layer 240 and the second intermediate metal layer 250 is in a range from about 0.01 μm to about 4 μm. In some embodiments, the width “W” of the first metal layer 160, the second metal layer 200, the first intermediate metal layer 240 and the second intermediate metal layer 250 is in a range from about 0.01 μm to about 100 μm, as shown in FIG. 5A. FIG. 5A is a cross-sectional view taken along line A-A′ of FIG. 5. In some embodiments, the spacing “S” of the patterned metal layers of the first intermediate metal layer 240 and the second intermediate metal layer 250 is in a range from about 0.01 μm to about 10 μm.

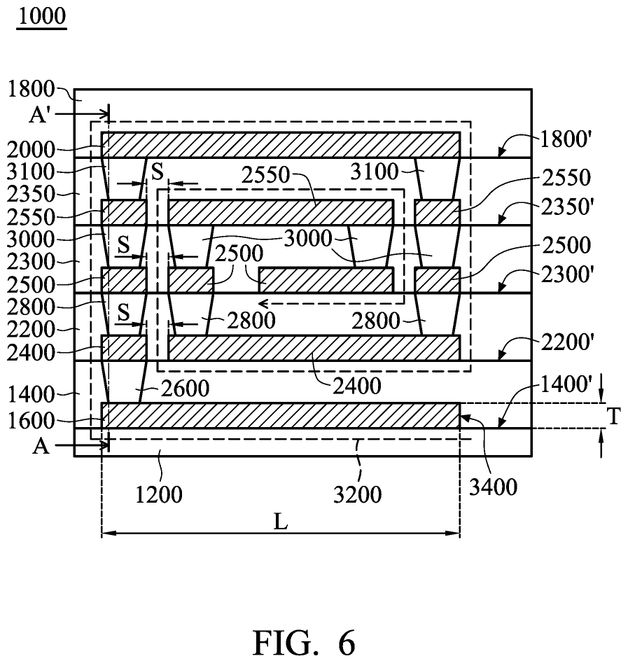

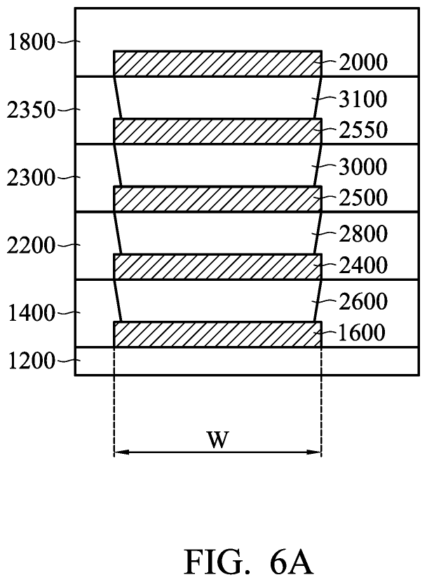

Referring to FIG. 6, in accordance with one embodiment of the invention, an inductor structure 1000 is provided. FIG. 6 is a cross-sectional view of the inductor structure 1000.

As shown in FIG. 6, in this embodiment, the inductor structure 1000 includes a substrate 1200, a first dielectric layer 1400, a first metal layer 1600, a second dielectric layer 1800, a second metal layer 2000, a first intermediate dielectric layer 2200, a second intermediate dielectric layer 2300, a third intermediate dielectric layer 2350, a first intermediate metal layer 2400, a second intermediate metal layer 2500, a third intermediate metal layer 2550, and a plurality of vias (2600, 2800, 3000 and 3100). The first dielectric layer 1400 is formed on the substrate 1200. The first metal layer 1600 is formed in the first dielectric layer 1400 and located on the bottom 1400′ of the first dielectric layer 1400. The second dielectric layer 1800 is formed on the first dielectric layer 1400. The second metal layer 2000 is formed in the second dielectric layer 1800 and located on the bottom 1800′ of the second dielectric layer 1800. The first metal layer 1600 and the second metal layer 2000 are continuous metal layers. The first intermediate dielectric layer 2200 is formed on the first dielectric layer 1400. The first intermediate metal layer 2400 is formed in the first intermediate dielectric layer 2200 and located on the bottom 2200′ of the first intermediate dielectric layer 2200. The second intermediate dielectric layer 2300 is formed on the first intermediate dielectric layer 2200. The second intermediate metal layer 2500 is formed in the second intermediate dielectric layer 2300 and located on the bottom 2300′ of the second intermediate dielectric layer 2300. The third intermediate dielectric layer 2350 is formed on the second intermediate dielectric layer 2300. The third intermediate metal layer 2550 is formed in the third intermediate dielectric layer 2350 and located on the bottom 2350′ of the third intermediate dielectric layer 2350. The first intermediate metal layer 2400, the second intermediate metal layer 2500 and the third intermediate metal layer 2550 are patterned metal layers.

The vias (2600, 2800, 3000 and 3100) are connected to the first metal layer 1600 and the first intermediate metal layer 2400, connected to the first intermediate metal layer 2400 and the second intermediate metal layer 2500, connected to the second intermediate metal layer 2500 and the third intermediate metal layer 2550, and connected to the second metal layer 2000 and the third intermediate metal layer 2550. For example, the via 2600 is connected to the first metal layer 1600 and the first intermediate metal layer 2400. The via 2800 is connected to the first intermediate metal layer 2400 and the second intermediate metal layer 2500. The via 3000 is connected to the second intermediate metal layer 2500 and the third intermediate metal layer 2550. The via 3100 is connected to the second metal layer 2000 and the third intermediate metal layer 2550. Specifically, the first metal layer 1600, the via 2600, the first intermediate metal layer 2400, the via 2800, the second intermediate metal layer 2500, the via 3000, the third intermediate metal layer 2550, the via 3100, the second metal layer 2000, the via 3100, the third intermediate metal layer 2550, the via 3000, the second intermediate metal layer 2500, the via 2800, the first intermediate metal layer 2400, the via 2800, the second intermediate metal layer 2500, the via 3000, the third intermediate metal layer 2550, the via 3000, and the second intermediate metal layer 2500 form an extension path 3200 which extends in a clockwise spiral mode. Similarly, the extension path 3200 takes the starting point 3400 of the first metal layer 1600 as an extension starting point, as shown in the cross-sectional view of FIG. 6.

In some embodiments, the substrate 1200 includes a silicon substrate or other suitable substrate materials. In some embodiments, the first dielectric layer 1400, the second dielectric layer 1800, the first intermediate dielectric layer 2200, the second intermediate dielectric layer 2300 and the third intermediate dielectric layer 2350 include silicon nitride, silicon oxide, silicon oxynitride or other suitable low-dielectric-constant dielectric materials. In some embodiments, the first metal layer 1600, the second metal layer 2000, the first intermediate metal layer 2400, the second intermediate metal layer 2500 and the third intermediate metal layer 2550 include copper, aluminum or other suitable metal conductive materials. In some embodiments, the vias (2600, 2800, 3000 and 3100) are filled with, for example, copper, tungsten or other suitable metal conductive materials.

In some embodiments, the length “L” of the first metal layer 1600, the second metal layer 2000, the first intermediate metal layer 2400, the second intermediate metal layer 2500 and the third intermediate metal layer 2550 is in a range from about 1 μm to about 100 μm. In some embodiments, the thickness “T” of the first metal layer 1600, the second metal layer 2000, the first intermediate metal layer 2400, the second intermediate metal layer 2500 and the third intermediate metal layer 2550 is in a range from about 0.01 μm to about 4 μm. In some embodiments, the width “W” of the first metal layer 1600, the second metal layer 2000, the first intermediate metal layer 2400, the second intermediate metal layer 2500 and the third intermediate metal layer 2550 is in a range from about 0.01 μm to about 100 μm, as shown in FIG. 6A. FIG. 6A is a cross-sectional view taken along line A-A′ of FIG. 6. In some embodiments, the spacing “S” of the patterned metal layers of the first intermediate metal layer 2400, the second intermediate metal layer 2500 and the third intermediate metal layer 2550 is in a range from about 0.01 μm to about 10 μm.

The present invention provides a specific connection manner to connect metal layers and vias along a vertical direction to fabricate an inductor component. To increase the number of inductive turns of the inductor component, it is only necessary to increase the number of layers of the metal layer along the vertical direction. That is, the increase in the number of inductive turns of the inductor component does not cause an increase in the area occupied on the plane (i.e. along the horizontal direction). Also, the fabrication process of the present invention is not difficult, and it can be combined with general semiconductor processes to fabricate the component easily. In addition, the present invention does possess a considerable process window when various wire widths of metal wires are designed to be fabricated. That is, there is no need to worry that arbitrarily increasing the wire width of the metal wires will cause a loading of the area occupied by the component, so an inductor component having any appropriate wire width can be easily fabricated. Furthermore, due to the reduced area occupied on the plane (i.e. along the horizontal direction), the effects of the inductor component of the present invention on adjacent component regions are substantially reduced, particularly the restrictions on the area used by adjacent components. That is, the present invention provides more convenient options for the placement of various other components.

While the invention has been described by way of example and in terms of preferred embodiment, it should be understood that the invention is not limited thereto. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An inductor structure, comprising:
a substrate;
a first dielectric layer formed on the substrate;
a first metal layer formed in the first dielectric layer;
a second dielectric layer formed on the first dielectric layer;
a second metal layer formed in the second dielectric layer, wherein the first metal layer and the second metal layer are continuous metal layers;
at least one intermediate dielectric layer formed between the first dielectric layer and the second dielectric layer;
at least one intermediate metal layer formed in the at least one intermediate dielectric layer, wherein the at least one intermediate metal layer is a patterned metal layer; and
a plurality of vias connected to the first metal layer and the at least one intermediate metal layer and connected to the second metal layer and the at least one intermediate metal layer, wherein the first metal layer, the vias, the at least one intermediate metal layer, and the second metal layer form an extension path which extends in a counterclockwise spiral mode, and the extension path has a starting point on the first metal layer.

2. The inductor structure as claimed in claim 1, wherein the first metal layer, the second metal layer and the at least one intermediate metal layer have a length which is in a range from about 1 μm to about 100 μm.

3. The inductor structure as claimed in claim 1, wherein the first metal layer, the second metal layer and the at least one intermediate metal layer have a thickness which is in a range from about 0.01 μm to about 4 μm.

4. The inductor structure as claimed in claim 1, wherein the first metal layer, the second metal layer and the at least one intermediate metal layer have a width which is in a range from about 0.01 μm to about 100 μm.

5. The inductor structure as claimed in claim 1, wherein the patterned metal layer of the at least one intermediate metal layer has a spacing which is in a range from about 0.01 μm to about 10 μm.

6. The inductor structure as claimed in claim 1, wherein the at least one intermediate dielectric layer comprises a single-layer intermediate dielectric layer, and the at least one intermediate metal layer comprises a single-layer intermediate metal layer.

7. The inductor structure as claimed in claim 1, wherein the at least one intermediate dielectric layer comprises dual-layer intermediate dielectric layers, and the at least one intermediate metal layer comprises dual-layer intermediate metal layers.

8. The inductor structure as claimed in claim 7, further comprising a plurality of vias connected to the intermediate metal layers located at different layers.

9. The inductor structure as claimed in claim 1, wherein the at least one intermediate dielectric layer comprises triple-layer intermediate dielectric layers, and the at least one intermediate metal layer comprises triple-layer intermediate metal layers.

10. The inductor structure as claimed in claim 9, further comprising a plurality of vias connected to the intermediate metal layers located at different layers.

11. An inductor structure, comprising:
a substrate;
a first dielectric layer formed on the substrate;
a first metal layer formed in the first dielectric layer;
a second dielectric layer formed on the first dielectric layer;
a second metal layer formed in the second dielectric layer, wherein the first metal layer and the second metal layer are continuous metal layers;
at least one intermediate dielectric layer formed between the first dielectric layer and the second dielectric layer;
at least one intermediate metal layer formed in the at least one intermediate dielectric layer, wherein the at least one intermediate metal layer is a patterned metal layer; and
a plurality of vias connected to the first metal layer and the at least one intermediate metal layer and connected to the second metal layer and the at least one intermediate metal layer, wherein the first metal layer, the vias, the at least one intermediate metal layer, and the second metal layer form an extension path which extends in a clockwise spiral mode, and the extension path has a starting point on the first metal layer.

12. The inductor structure as claimed in claim 11, wherein the first metal layer, the second metal layer and the at least one intermediate metal layer have a length which is in a range from about 1 μm to about 100 μm.

13. The inductor structure as claimed in claim 11, wherein the first metal layer, the second metal layer and the at least one intermediate metal layer have a thickness which is in a range from about 0.01 μm to about 4 μm.

14. The inductor structure as claimed in claim 11, wherein the first metal layer, the second metal layer and the at least one intermediate metal layer have a width which is in a range from about 0.01 μm to about 100 μm.

15. The inductor structure as claimed in claim 11, wherein the patterned metal layer of the at least one intermediate metal layer has a spacing which is in a range from about 0.01 μm to about 10 μm.

16. The inductor structure as claimed in claim 11, wherein the at least one intermediate dielectric layer comprises a single-layer intermediate dielectric layer, and the at least one intermediate metal layer comprises a single-layer intermediate metal layer.

17. The inductor structure as claimed in claim 11, wherein the at least one intermediate dielectric layer comprises dual-layer intermediate dielectric layers, and the at least one intermediate metal layer comprises dual-layer intermediate metal layers.

18. The inductor structure as claimed in claim 17, further comprising a plurality of vias connected to the intermediate metal layers located at different layers.

19. The inductor structure as claimed in claim 11, wherein the at least one intermediate dielectric layer comprises triple-layer intermediate dielectric layers, and the at least one intermediate metal layer comprises triple-layer intermediate metal layers.

20. The inductor structure as claimed in claim 19, further comprising a plurality of vias connected to the intermediate metal layers located at different layers.
